(19) United States
(12) Patent Application Publication
(10) Pub. No.: US 2025/0065706 A1
(43) Pub. Date: Feb. 27, 2025

(54) HYDROGEN INTERNAL COMBUSTION ENGINE ARRANGEMENT

(71) Applicant: Volvo Truck Corporation, GÖTEBORG (SE)

(72) Inventors: Oscar Garnemark, TORSLANDA (SE); Fredrik Rahm, HÖRBY (SE); Lennart Andersson, SKÄLLINGE (SE); Marcus Rubensson, VÄSTRA FRÖLUNDA (SE)

(21) Appl. No.: 18/800,358

(22) Filed: Aug. 12, 2024

(30) Foreign Application Priority Data
Aug. 21, 2023 (EP) 23192411.9

(51) Int. Cl. B60K 6/24; B60K 6/485

(52) U.S. Cl. CPC B60K 6/24; B60K 6/485

(57) ABSTRACT

The present disclosure relates to an internal combustion engine arrangement comprising an internal combustion engine comprising a reciprocating piston connected to a crankshaft arranged in a crankcase, and a combustion chamber, wherein the crankcase and the combustion chamber are arranged on a respective side, in a reciprocating direction, of the reciprocating piston, a combustion chamber pressure controller arranged in fluid communication with the combustion chamber and configured to control a pressure level in the combustion chamber, and a control unit comprising processing circuitry configured to determine a pressure level in the combustion chamber, determine a pressure level in the crankcase, and control the combustion chamber pressure controller in response to a difference between the pressure level in the combustion chamber and the pressure level in the crankcase being below a predetermined threshold limit.

### CROSS REFERENCE TO RELATED APPLICATIONS

This application claims priority to European Patent Application No. 23192411.9, filed on Aug. 21, 2023, the disclosure and content of which is incorporated by reference herein in its entirety.

### TECHNICAL FIELD

The disclosure relates generally to internal combustion engines. In particular aspects, the disclosure relates to an internal combustion engine arrangement for a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Internal combustion engines have been conventionally used for propelling vehicles. A conventional internal combustion engine uses petrol or diesel as fuel. However, alternative fuels are recently becoming of interest as they are less environmentally harmful. One of such alternative fuels is hydrogen.

Hydrogen fuel can be used as a combustible fuel in an internal combustion, such as a so-called hydrogen internal combustion engine. However, the hydrogen fuel is, compared to a conventional petrol or diesel engine, injected at a low pressure into the combustion chamber. With the low pressure injection, the duration of the injection is longer compared to a high pressure injection event. The low pressure injection therefore needs to start at a relatively early point in time. There is hence a longer time period in which the fuel is able to react with e.g. residual oil that can as an igniter which may potentially result in particle emissions in the exhaust of combustion gas. There is thus a desire to further develop internal combustion engines to reduce the risk of oil residuals leaking into the combustion chamber.

### SUMMARY

According to a first aspect of the disclosure, there is provided an internal combustion engine arrangement for a vehicle, the internal combustion engine arrangement comprising an internal combustion engine comprising a reciprocating piston connected to a crankshaft arranged in a crankcase, and a combustion chamber, wherein the crankcase and the combustion chamber are arranged on a respective side, in a reciprocating direction, of the reciprocating piston, combustion chamber pressure controller arranged in fluid communication with the combustion chamber and configured to control a pressure level in the combustion chamber, and a control unit comprising processing circuitry, the processing circuitry being configured to determine a pressure level in the combustion chamber, determine a pressure level in the crankcase, and control the combustion chamber pressure controller in response to a difference between the pressure level in the combustion chamber and the pressure level in the crankcase being below a predetermined threshold limit.

The first aspect of the disclosure may seek to reduce particle emissions for an internal combustion engine. In particular, the present disclosure seeks to reduce the particle emissions coming from oil residuals in the crankcase. By controlling the combustion pressure controller to maintain a higher pressure level in the combustion chamber compared to the pressure level in the crankcase, a technical advantage may be that the risk of oil residual in the crankcase leaking through the piston rings up to the combustion chamber can be substantially reduced. Accordingly, by controlling the pressure in the combustion chamber to be higher than the pressure in the crankcase, the oil will stay in the crankcase and not mixed or burned with the exhaust gas, which would otherwise cause particle emissions. The hydrogen internal combustion engine arrangement may thus enable for a more environmentally friendly arrangement.

The pressure level in the combustion chamber can be controlled by the above described combustion chamber pressure controller. As will be described below, the combustion chamber pressure controller can be one, or both, of a turbine and a compressor. The combustion chamber pressure controller can, as an alternative or as a complement, be a valve or throttle arranged at the inlet to the combustion chamber, and/or a throttle or valve arranged downstream an exhaust outlet of the combustion chamber. The pressure level may be an instant pressure level for each piston cycle, where the pressure level in each combustion chamber is maintained higher than the pressure level in the crankcase for each piston cycle. The pressure level in the combustion chamber may be the pressure level in the inlet manifold of the internal combustion engine, i.e. the pressure level in an intake duct. The pressure level may also be an average pressure for each cycle, where the average pressure level in the combustion chamber should be higher than the average pressure level in the crankcase. As a further alternative, the lowest pressure in any of the combustion chambers may be determined. This can be done by measuring or determining a pressure level in at least one of the inlet manifold or the exhaust manifold. This lowest pressure is thereafter compared to the pressure level in the crankcase.

Optionally, in some examples, the combustion chamber pressure controller may be a turbine and/or a compressor. A technical benefit may include that the pressure level in the combustion chamber can be controlled by controlling the rotational speed of the turbine and/or the rotational speed of the compressor. The pressure level can alternatively be controlled by using a so-called variable geometry turbine, VGT, where the swallowing capacity of the VGT can be controlled by controlling the variable turbine nozzle position of the VGT, and thereby also the pressure level in the combustion chamber.

Optionally, in some examples, the combustion chamber pressure controller may be a turbo arrangement comprising a turbine arranged in downstream fluid communication with an exhaust port to the combustion chamber and a compressor arranged in upstream fluid communication with an intake port to the combustion chamber.

Optionally, in some examples, the turbo arrangement may be an electrically controlled turbo arrangement. A technical benefit may include that the rotational speed of an electrically controlled turbo arrangement can be rapidly controlled, thereby rapidly changing the pressure level in the combustion chamber.

Optionally, in some examples, the electrically controlled turbo arrangement may comprise an electric turbo motor between the turbine and the compressor. The turbo arrangement using an electric turbo motor may also be referred to as an E-turbo. A technical benefit may include that the electric turbo motor may rapidly control the rotational speed of the turbo. Also, the turbo arrangement can be controlled by an external element other than the flow velocity of the combustion gas exhausted from the combustion chamber.

Optionally, in some examples, the electric turbo motor may be operatively coupled to the processing circuit.

Optionally, in some examples, the internal combustion engine may further comprise a supplementary motor connected to the crankshaft. A technical benefit may include that the supplementary motor can control the rotational speed of the crankshaft. For example, the supplementary motor can add a torque on the crankshaft for compensating for a potential loss of crankshaft torque caused by controlling the pressure level in the combustion chamber. The supplementary motor may be directly connected to the crankshaft, or indirectly connected to the crankshaft, such as through a gear stage, etc.

Optionally, in some examples, the supplementary motor may be an electric machine operatively coupled to the processing circuit. A technical benefit may include that an electric machine may rapidly respond to data signals received from the processing circuitry. Thus, when the combustion chamber pressure controller controls the pressure level in the combustion chamber, the electric machine may rapidly control the torque on the crankshaft if the torque falls outside a desired torque level or torque range.

Optionally, in some examples, the electric machine may be operable as an electric motor and as a generator. A technical benefit may include that the electric machine may apply a torque on the crankshaft as well as generate electric power. The electric machine may thus both increase the torque on the crankshaft as well as reduce the torque on the crankshaft.

Optionally, in some examples, the electric machine may be electrically connected to the combustion chamber pressure controller, the electric machine being configured to feed electric power to the combustion chamber pressure controller. A technical benefit may include that the electric machine may feed electric power to the combustion chamber pressure controller when generating electric power. The combustion chamber pressure controller may hereby receive power from the electric machine to control the pressure level in the combustion chamber to be higher than the pressure level in the crankcase during low load operations, idling and/or at negative torque transients.

Optionally, in some examples, the processing circuit may be further configured to determine a desired output torque on the crankshaft, and control the supplementary motor and the combustion chamber pressure controller contemporaneously in response to a difference between a current output torque and the desired output torque being above a predetermined torque threshold limit. A technical benefit may include that the pressure level in the combustion chamber is maintained higher than the pressure level in the crankcase, while maintaining the desired output torque on the crankshaft.

Optionally, in some examples, the supplementary motor may be directly attached to the crankshaft. As described above, the supplementary motor may alternatively be indirectly connected to the crankshaft, such as through a gear stage, etc.

Optionally, in some examples, the internal combustion engine arrangement may further comprise a first pressure sensor and a second pressure sensor. A third pressure sensor may also be used in addition to the first and second pressure sensors. Such third pressure sensor may preferably be arranged to detect the pressure level of the combustion gas exhausted from the combustion chamber.

Optionally, in some examples, the first pressure sensor may be configured to determine a first pressure value indicative of a pressure level in the combustion chamber.

Optionally, in some examples, the second pressure sensor may be configured to determine a second pressure value indicative of a pressure level in the crankcase.

Optionally, in some examples, the first and second pressor sensors may be operatively coupled to the processing circuit. A technical benefit may include that the first and second pressure sensors may rapidly transmit instant pressure values to the processing circuitry.

Optionally, in some examples, the processing circuitry may be configured to determine the pressure level in the combustion chamber from a memory comprising a plurality of stored pressure levels for a plurality of stored engine operating conditions. A technical benefit may include that the processing circuitry may be able to determine the pressure level in the combustion chamber without the use of e.g. a pressure sensor.

Optionally, in some examples, the internal combustion engine is a hydrogen internal combustion engine. A hydrogen internal combustion engine is conventionally receiving injected hydrogen at a low pressure level. With the low pressure injection, the duration of the injection may be longer compared to a high pressure injection event. The low pressure injection may therefore need to start at a relatively early point in time. There is hence a longer time period in which the fuel is able to react with e.g. residual oil that can as an igniter which may potentially result in particle emissions in the exhaust of combustion gas. Controlling the pressure levels as described above may thus be particularly advantageous for a hydrogen internal combustion engine arrangement.

According to a second aspect, there is provided a vehicle comprising the internal combustion engine arrangement of any one of the examples of the first aspect.

According to a third aspect, there is provided a method of controlling an internal combustion engine arrangement, comprising an internal combustion engine, and a combustion chamber pressure controller arranged in fluid communication with a combustion chamber of the internal combustion engine, wherein the combustion chamber pressure controller is configured to control a pressure level in the combustion chamber, the method comprising determining a pressure level in the combustion chamber of the internal combustion engine, determining a pressure level in a crankcase of the internal combustion engine, and controlling the combustion chamber pressure controller in response to a difference between the pressure level in the combustion chamber and the pressure level in the crankcase being below a predetermined threshold limit.

Effects and features of the second and third aspects are largely analogous to those described above in relation to the first aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary illustration of a vehicle according to an example,

FIG. 2 is an exemplary illustration of a hydrogen internal combustion engine arrangement according to an example,

FIG. 3 is an exemplary illustration of a hydrogen internal combustion engine according to an example,

FIG. 4 is an exemplary illustration of a hydrogen internal combustion engine arrangement according to an example,

FIG. 5 is an exemplary illustration of a flow chart of a method of controlling a hydrogen internal combustion engine arrangement, and

FIG. 6 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The disclosure described in the following may seek to reduce particle emissions exhausted from an internal combustion engine. In particular, the following disclosure may preferably reduce particle emissions coming from oil residuals in the crankcase such as e.g. for low pressure injection engines. An advantages may thus be that a more environmentally friendly internal combustion engine arrangement may be provided.

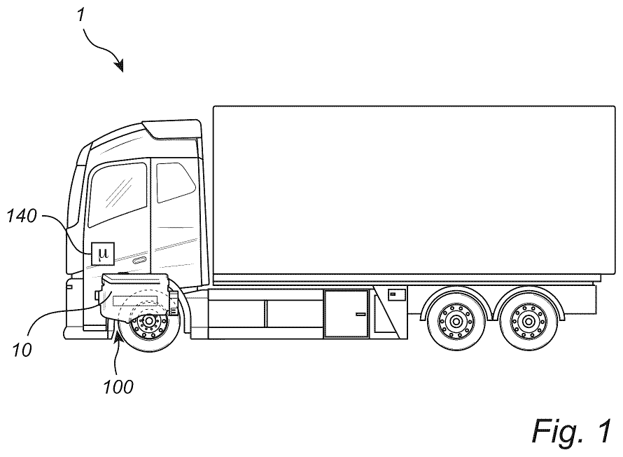

Reference is made to FIG. 1, which is an exemplary illustration of a vehicle 1 according to an example. The vehicle 1 in FIG. 1 is exemplified as a truck, but the below description may be provided in other vehicles, such as e.g. working machines, buses, cars, etc. The vehicle 1 comprises an internal combustion engine arrangement 100. In the following, the internal combustion engine 100 will be referred to as a hydrogen internal combustion engine arrangement 100. However, the present disclosure should not be construed as limited to a hydrogen internal combustion engine arrangement 100 which merely serves the purpose of simplified understanding for the skilled reader. The hydrogen internal combustion engine arrangement 100 comprises a hydrogen internal combustion engine 10 configured to receive hydrogen gas for combustion in its combustion chamber(s). Further, the hydrogen internal combustion engine arrangement 100 also comprises a control unit 140. The control unit 140 comprises a processor device configured to control the hydrogen internal combustion engine arrangement 100 as will be described in further detail below.

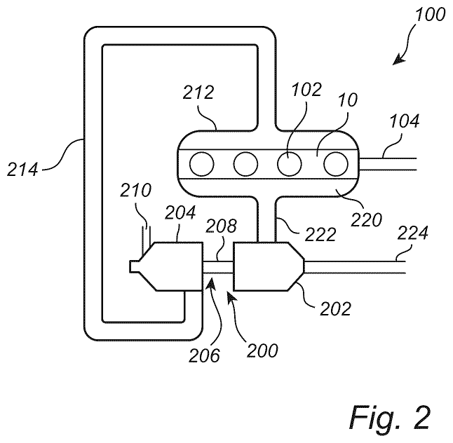

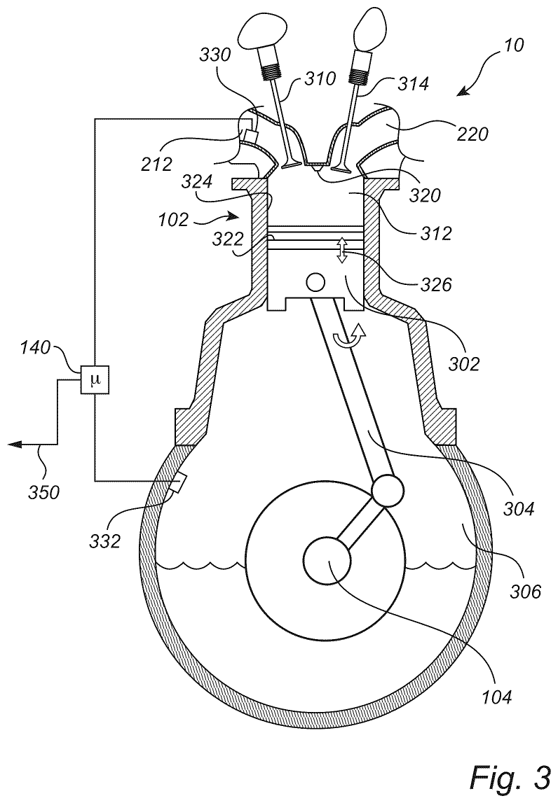

In order to describe the internal combustion engine arrangement 100 in further detail, reference is now made to FIG. 2 which is an exemplary illustration of the hydrogen internal combustion engine arrangement 100 according to an example. As can be seen in FIG. 2, the hydrogen internal combustion engine arrangement 100 comprises the above described hydrogen internal combustion engine 10. The hydrogen internal combustion engine 10 comprises a number of combustion cylinders 102, in FIG. 2 exemplified as four combustion cylinders 102, although this number should in no way be construed as exclusive for the present disclosure. As will be seen in FIG. 3, each of the combustion cylinders is provided with a reciprocating piston connected to a crankshaft 104 via a piston rod. The hydrogen internal combustion engine 10 may be operable by using all of the combustion cylinders 102. However, the torque to the crankshaft may be reduced by not feeding fuel to one or more combustion cylinders, i.e. to operate the internal combustion engine 10 by feeding fuel and air only some, but not all, of the combustion chambers.

Further, the hydrogen internal combustion engine arrangement 100 comprises a combustion chamber pressure controller 200. The combustion chamber pressure controller 200 is arranged in fluid communication with a combustion chamber (see FIG. 3) of the hydrogen internal combustion engine 10 and configured to control a pressure level in the combustion chamber. In the exemplified FIG. 2, the combustion chamber pressure controller 200 comprises at least one of a turbine 202 and a compressor 204. In the example depicted in FIG. 2, the combustion chamber pressure controller 200 comprises both the turbine 202 as well as the compressor 204. Hence, the combustion chamber pressure controller 200 is in the FIG. 2 example a turbo arrangement 206 and will in the following be referred to as such unless explicitly described otherwise. The turbo arrangement 206 comprises a turbo shaft 208 mechanically connecting the turbine 202 and the compressor 204 to each other.

The turbine 202 is arranged in fluid communication with an exhaust manifold 220 of the internal combustion engine arrangement 100 via turbine inlet conduit 222. Although not depicted in detail, the turbine 202 comprises turbine blades, whereby a rotational motion of a turbo shaft 208 is generated by the exhaust flow from the internal combustion engine 10. The exhaust gas from the internal combustion engine 10 is, after entering the turbine 202, fed through an exhaust conduit 224.

The compressor 204 comprises an air inlet conduit 210 configured to receive air. The compressor 204 is mechanically connected to the turbine 202 by the above described turbo shaft 208. The rotational motion of the turbo shaft 208 thus generates a rotation of the compressor 204, whereby the compressor 204 pressurizes the air received through the inlet conduit 210. The pressurized air is fed to an inlet manifold 212 of the internal combustion engine arrangement 100 via a compressor outlet conduit 214. Thus, pressurized air is fed into the combustion cylinders 102 of the hydrogen internal combustion engine 10.

Reference is now made to FIG. 3 which is an exemplary illustration of a hydrogen internal combustion engine 10 according to an example. As described above, the hydrogen internal combustion engine 10 comprises a combustion cylinder 102 housing a reciprocating piston 302. The reciprocating piston 302 is connected to the crankshaft 104 via a piston rod 304. The piston rod 304 is arranged in a crankcase 306 of the hydrogen internal combustion engine 306. Further, the piston 302 comprises piston rings 322. The piston rings 322 are arranged as sealing elements between the piston 302 and an inner surface 324 of the combustion cylinder 102 Further, a lubricating medium 308 is provided in the crankcase 304. The lubricating medium 308 is preferably oil configured to provide lubrication.

Further, the hydrogen internal combustion engine 10 is exemplified as comprising an inlet valve 310 configured to controllably direct air from the inlet manifold 212 into a combustion chamber 312 of the hydrogen internal combustion engine 10, as well as an exhaust valve 314 configured to controllably exhaust combusted gas to the exhaust manifold 220. The hydrogen internal combustion engine 10 also comprises an injector 320 configured to inject a flow of hydrogen gas into the combustion chamber 312. Although not depicted, the hydrogen internal combustion engine 10 may also comprise a spark plug.

As depicted in FIG. 3, the crankcase 306 and the combustion chamber 312 are arranged on a respective side of the reciprocating piston 302 as seen in a reciprocating direction 326 of the piston.

The present disclosure is based on the insight that by controlling the hydrogen internal combustion engine arrangement 100 in such a way that a pressure level in the combustion chamber 312 is higher than a pressure level in the crankcase 306, there may be a reduced risk that the lubricating medium is slipping through the piston rings 322 and end up in the combustion chamber 312. If this occurs, residuals form the lubricating medium will be exhausted to the exhaust manifold 220 after a combustion process in the combustion chamber 312 which may result in less environmentally friendly particles will be exhausted to the ambient environment.

To mitigate this risk, the control unit 140 of the present disclosure determines a pressure level in the combustion chamber 312. The pressure level in the combustion chamber 312 can be determined by receiving a signal indicative of such pressure by a first pressure sensor 330. Hence, the first pressure sensor 330 is electrically connected to the control unit 140. The first pressure sensor 330 is exemplified as arranged in the inlet manifold 212 although other positions are conceivable. The pressure level in the combustion chamber 312 may however be determined without the use of the first pressure sensor 330. For example, the pressure level in the combustion chamber 312 may be determined from a memory comprising a plurality of stored pressure levels for a respective plurality of stored engine operating conditions. These pressure values and operating conditions may be obtained from previous driving operations by the vehicle, or from testing, etc.

Further, the control unit 140 determines a pressure level in the crankcase 306. The pressure level in the crankcase 306 can be determined by receiving a signal indicative of such pressure by a second pressure sensor 332. Hence, the second pressure sensor 332 is electrically connected to the control unit 140. The second pressure sensor 332 is exemplified as arranged in the crankcase 306 although other positions are conceivable. The pressure level in the crankcase 306 may however be determined without the use of the second pressure sensor 332. For example, the pressure level in the crankcase 306 may be determined from a memory comprising a plurality of stored pressure levels for a respective plurality of stored engine operating conditions. These pressure values and operating conditions may be obtained from previous driving operations by the vehicle, or from testing, etc.

If a difference between the pressure level in the combustion chamber 312 and the pressure level in the crankcase 306 is below a predetermined threshold limit, the control unit 140 controls the combustion chamber pressure controller 200, i.e. the turbo arrangement 206 described above in relation to FIG. 2. In further detail, the control unit 140 transmits a control signal 350 to the turbo arrangement for adjusting its operation. The turbo arrangement 206 may, as an example, be controlled to adjust its swallowing capacity, which in turn can change the rotational speed of the turbo shaft. In particular, if the rotational speed of the turbo shaft is increased, the compressor will increase the pressure of the air to thereby increase the pressure of the air in the inlet manifold and thus increase the pressure level in the combustion chamber.

The predetermined threshold limit may be a limit which is zero, i.e. the control unit 140 controls the turbo arrangement 206 when the pressure level in the combustion chamber 312 is equal to the pressure level in the crankcase 306. The predetermined threshold limit may however be higher than zero such as to continuously maintain a certain safety factor that the pressure in the combustion chamber will be higher than the pressure level in the crankcase 306.

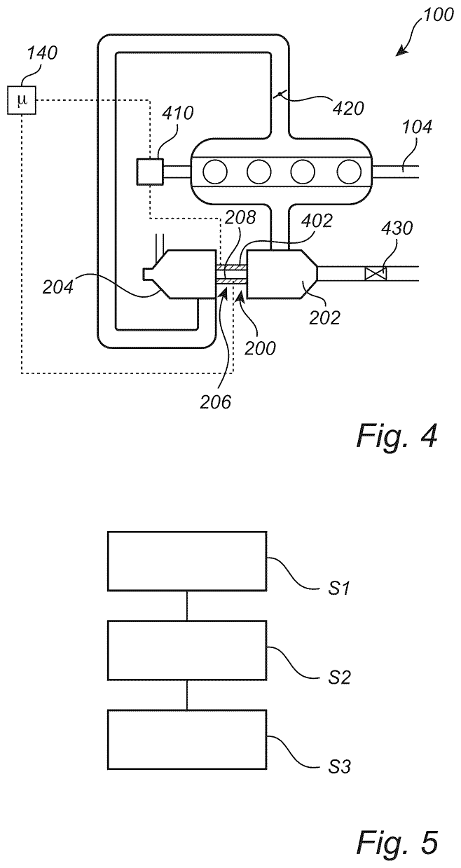

Reference is now made to FIG. 4 which is an exemplary illustration of the hydrogen internal combustion engine according to an example. The example in FIG. 4 comprises the features described above in relation to FIGS. 2 and 3 and the following will only describe the features which are made in addition to the previous description for simplifying for the skilled reader.

In the example depicted in FIG. 4, the combustion chamber pressure controller 200 also comprises a throttle 420 at the inlet manifold, as well as a throttle/valve 430 at the exhaust from the turbine 202. The throttle/valve 430 may alternatively, or additionally, be arranged in the exhaust upstream the turbine. By controlling the throttle 420 at the inlet manifold, the pressure level in the combustion chamber can be controlled. In detail, reducing the level of air fed into the combustion chamber will reduce the pressure level in the combustion chamber. Hence, the throttle can be opened to increase the pressure before the turbo arrangement is controlled to increase the pressure level. The throttle/valve 430 at the exhaust may advantageously be controlled during an engine braking operation mode or when there is a desired to increase a temperature level of an exhaust gas aftertreatment system of the internal combustion engine arrangement. As further depicted in the example of FIG. 4, the turbo arrangement 206 is an electrically controlled turbo arrangement 206. In particular, the electrically controlled turbo arrangement 206 comprises an electric turbo motor 402 arranged between the turbine 202 and the compressor 204. In particular, the electric turbo motor 402 is arranged in the turbo shaft 208, or forms the turbo shaft 208. By means of the electric turbo motor 402, the speed of the turbine arrangement can be controlled. In other words, the speed of the turbine 202 as well as the compressor 204 can be increased or decreased by the electric turbo motor 402. Hence, the speed of the turbine 202 and the compressor 204 can be controlled by the exhaust flow from the combustion chamber 312 as well as by applying a torque using the electric turbo motor 402.

The electric turbo motor 402 is operatively coupled to the control unit 140. When the control unit 140 is operative to control the turbo arrangement in response to a difference between the pressure level in the combustion chamber and the pressure level in the crankcase being below a predetermined threshold limit, the control unit 140 may thus control the applied torque of the electric turbo motor 402 to thus increase a pressure difference between the combustion chamber 312 and the crankcase 306.

The FIG. 4 example also comprises a supplementary motor 410 connected to the crankshaft 104. The supplementary motor 410 is connected to the crankshaft 104 of the internal combustion engine arrangement 100. By the supplementary motor 410, the speed of the crankshaft 104 can be controlled. Put it differently, the rotational speed of the crankshaft 104 can be varied, i.e. increased or decreased, by means of the supplementary motor 410 applying a torque or generating electric power. Although not depicted in the figure, the supplementary motor 410 is preferably connected to an electric power source for receiving electric power when applying a torque. When the supplementary motor 410 generates electric power by reducing the rotational speed of the crankshaft 104, electric power can be fed from the supplementary motor 410 to such electric power source. The electric power source may be a vehicle battery.

The supplementary motor 410 is thus preferably an electric machine which can operate as a motor as well as a generator. As depicted in FIG. 4, the supplementary motor 410 is operatively coupled to the control unit 140. The supplementary motor 410 is also in the example of FIG. 4 electrically connected to the combustion chamber pressure controller 200. More specifically, the supplementary motor 410 is preferably electrically connected to the electric turbo motor 208 of the combustion chamber pressure controller 200. Hereby, electric power can be fed between the supplementary motor 410 and the supplementary motor 410.

During operation, and as discussed above, the combustion chamber pressure controller 200 is controlled such as to obtain a higher pressure level in the combustion chamber 312 compared to the pressure level in the crankcase 306. However, to obtain a desired operation of the internal combustion engine arrangement 100, the control unit 140 may determine a desired output torque of the crankshaft 104 and thereafter control the supplementary motor 410 and the combustion chamber pressure controller 200 contemporaneously in response to a difference between a current output torque and the desired output torque being above a predetermined torque threshold limit. Hereby, the pressure level will be maintained higher in the combustion chamber 312 compared to the pressure level in the crankcase 306, while the output torque on the crankshaft 104 will be at an approximate desired level. The contemporaneous control of the supplementary motor 410 and the combustion chamber pressure controller 200 is based on the insight that the torque on the crankshaft may be negatively affected, i.e. be undesirably increased or reduced, when solely controlling the combustion chamber pressure controller 200 to obtain a higher pressure level in the combustion chamber 312.

Further, the control unit may also be configured to control the flow of fuel to the combustion chamber, as well as to control the flow of air fed to the combustion chamber. Hereby, the torque on the crankshaft may be controlled. Also, the internal combustion engine arrangement may comprise an electrically controlled booster, i.e. an electrically controlled compressor, also referred to as an e-booster. Such e-booster may be arranged at the inlet manifold, or upstream the inlet manifold, to increase the pressure of the air fed into the combustion cylinder. The e-booster may be connected to the inlet manifold via a by-pass conduit to controllably increase the air pressure when there is a desire to do so. Obviously, such e-booster is preferably operable by the above described control unit.

In order to sum up, reference is made to FIG. 5 which is an exemplary illustration of a flow chart of a method of controlling the hydrogen internal combustion arrangement. During operation of the internal combustion engine described above in relation to FIGS. 2-4, the control unit 140 determines S1 a pressure level in the combustion chamber 312 of the hydrogen internal combustion engine 10. The control unit 140 also determines S2 a pressure level in the crankcase 306 of the hydrogen internal combustion engine 10. Thereafter, and in response to the difference between the pressure level in the combustion chamber 312 and the pressure level in the crankcase 306 being below a predetermined threshold limit, the control unit 140 controls the combustion chamber pressure controller 200, i.e. the turbo arrangement 206. Thus, the turbo arrangement 206 is controlled such as to obtain an increased difference between the pressure level in the combustion chamber 312 and the pressure level in the crankcase 306, where the pressure level in the combustion chamber 312 should be higher than the pressure level in the crankcase 306.

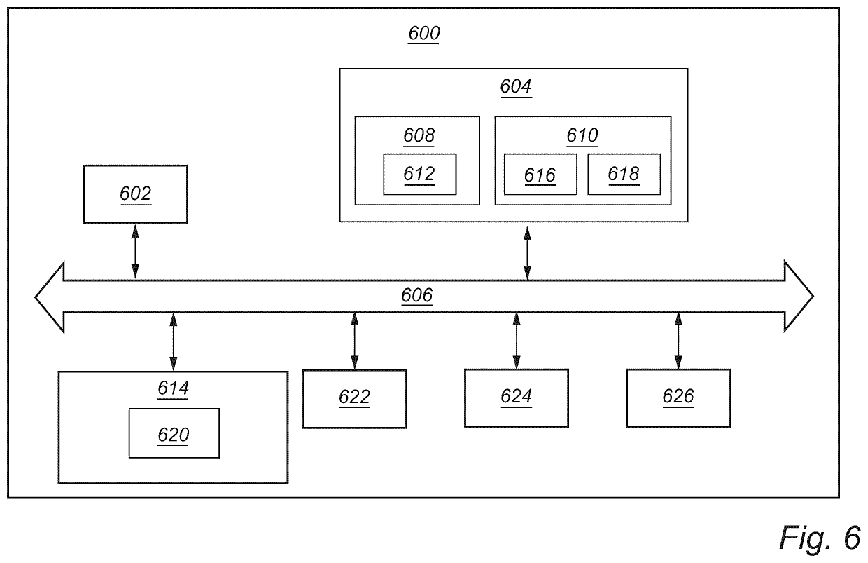

Turning now to FIG. 6, which is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include processing circuitry 602 (e.g., processing circuitry including one or more processor devices or control units), a memory 604, and a system bus 606. The computer system 600 may include at least one computing device having the processing circuitry 602. The system bus 606 provides an interface for system components including, but not limited to, the memory 604 and the processing circuitry 602. The processing circuitry 602 may include any number of hardware components for conducting data or signal processing or for executing computer code stored in memory 604. The processing circuitry 602 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 602 may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processing circuitry 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures and which can be accessed by a computer or other machine with processing circuitry 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program 620 stored on a transitory or non-transitory computer-usable or computer-readable storage medium (e.g., single medium or multiple media), such as the storage device 614, which includes complex programming instructions (e.g., complex computer-readable program code) to cause the processing circuitry 602 to carry out actions described herein. Thus, the computer-readable program code of the computer program 620 can comprise software instructions for implementing the functionality of the examples described herein when executed by the processing circuitry 602. In some examples, the storage device 614 may be a computer program product (e.g., readable storage medium) storing the computer program 620 thereon, where at least a portion of a computer program 620 may be loadable (e.g., into a processor) for implementing the functionality of the examples described herein when executed by the processing circuitry 602. The processing circuitry 602 may serve as a controller or control system for the computer system 600 that is to implement the functionality described herein.

The computer system 600 may include an input device interface 622 configured to receive input and selections to be communicated to the computer system 600 when executing instructions, such as from a keyboard, mouse, touch-sensitive surface, etc. Such input devices may be connected to the processing circuitry 602 through the input device interface 622 coupled to the system bus 606 but can be connected through other interfaces, such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may include a communications interface 626 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

### Example List

Example 1: An internal combustion engine arrangement for a vehicle, the internal combustion engine arrangement comprising an internal combustion engine comprising a reciprocating piston connected to a crankshaft arranged in a crankcase, and a combustion chamber, wherein the crankcase and the combustion chamber are arranged on a respective side, in a reciprocating direction, of the reciprocating piston, a combustion chamber pressure controller arranged in fluid communication with the combustion chamber and configured to control a pressure level in the combustion chamber, and a control unit comprising processing circuitry, the processing circuitry being configured to: determine a pressure level in the combustion chamber, determine a pressure level in the crankcase, and control the combustion chamber pressure controller in response to a difference between the pressure level in the combustion chamber and the pressure level in the crankcase being below a predetermined threshold limit.

Example 2. The internal combustion engine arrangement of example 1, wherein the combustion chamber pressure controller is a turbine and/or a compressor.

Example 3. The internal combustion engine arrangement of any one of examples 1 or 2, wherein the combustion chamber pressure controller is a turbo arrangement comprising a turbine arranged in downstream fluid communication with an exhaust port to the combustion chamber and a compressor arranged in upstream fluid communication with an intake port to the combustion chamber.

Example 4. The internal combustion engine arrangement of example 3, wherein the turbo arrangement is an electrically controlled turbo arrangement.

Example 5. The internal combustion engine arrangement of example 4, wherein the electrically controlled turbo arrangement comprises an electric turbo motor between the turbine and the compressor.

Example 6. The hydrogen internal combustion engine arrangement of example 5, wherein the electric turbo motor is operatively coupled to the processing circuit.

Example 7. The internal combustion engine arrangement of any one of the preceding examples, further comprising a supplementary motor connected to the crankshaft.

Example 8. The internal combustion engine arrangement of example 7, wherein the supplementary motor is an electric machine operatively coupled to the processing circuit.

Example 9. The hydrogen internal combustion engine arrangement of example 8, wherein the electric machine is operable as an electric motor and as a generator.

Example 10. The internal combustion engine arrangement of any one of examples 8 or 9, wherein the electric machine is electrically connected to the combustion chamber pressure controller, the electric machine being configured to feed electric power to the combustion chamber pressure controller.

Example 11. The internal combustion engine arrangement of any one of examples 7-10, wherein the processing circuit is further configured to: determine a desired output torque on the crankshaft, and control the supplementary motor and the combustion chamber pressure controller contemporaneously in response to a difference between a current output torque and the desired output torque being above a predetermined torque threshold limit.

Example 12. The hydrogen internal combustion engine arrangement of any one of examples 7-11, wherein the supplementary motor is directly attached to the crankshaft.

Example 13. The internal combustion engine arrangement of any one of the preceding examples, further comprising a first pressure sensor and a second pressure sensor.

Example 14. The internal combustion engine arrangement of example 13, wherein the first pressure sensor is configured to determine a first pressure value indicative of a pressure level in the combustion chamber.

Example 15. The internal combustion engine arrangement of any one of examples 13 or 14, wherein the second pressure sensor is configured to determine a second pressure value indicative of a pressure level in the crankcase.

Example 16. The hydrogen internal combustion engine arrangement of any one of examples 13-15, wherein the first and second pressor sensors are operatively coupled to the processing circuit.

Example 17. The internal combustion engine arrangement of any one of the preceding examples, wherein the processing circuitry is configured to determine the pressure level in the combustion chamber from a memory comprising a plurality of stored pressure levels for a plurality of stored engine operating conditions.

Example 18. The internal combustion engine arrangement of example 17, wherein the processing circuitry is further configured to determine the pressure level in the crankcase from the memory, the memory further comprising a plurality of stored pressure levels in the crankcase for the plurality of stored engine operating conditions.

Example 19. The internal combustion engine arrangement of any of the preceding examples, wherein the internal combustion engine is a hydrogen internal combustion engine.

Example 20. A vehicle comprising the internal combustion engine arrangement of any one of the preceding examples.

Example 21. A method of controlling an internal combustion engine arrangement, comprising an internal combustion engine, and a combustion chamber pressure controller arranged in fluid communication with a combustion chamber of the internal combustion engine, wherein the combustion chamber pressure controller is configured to control a pressure level in the combustion chamber, the method comprising: determining a pressure level in the combustion chamber of the internal combustion engine, determining a pressure level in a crankcase of the internal combustion engine, and controlling the combustion chamber pressure controller in response to a difference between the pressure level in the combustion chamber and the pressure level in the crankcase being below a predetermined threshold limit.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. An internal combustion engine arrangement for a vehicle, the internal combustion engine arrangement comprising an internal combustion engine comprising a reciprocating piston connected to a crankshaft arranged in a crankcase, and a combustion chamber, wherein the crankcase and the combustion chamber are arranged on a respective side, in a reciprocating direction, of the reciprocating piston, a combustion chamber pressure controller arranged in fluid communication with the combustion chamber and configured to control a pressure level in the combustion chamber, and a control unit comprising processing circuitry, the processing circuitry being configured to: determine a pressure level in the combustion chamber, determine a pressure level in the crankcase, and control the combustion chamber pressure controller in response to a difference between the pressure level in the combustion chamber and the pressure level in the crankcase being below a predetermined threshold limit.

2. The internal combustion engine arrangement of claim 1, wherein the combustion chamber pressure controller is a turbine and/or a compressor.

3. The internal combustion engine arrangement of claim 1, wherein the combustion chamber pressure controller is a turbo arrangement comprising a turbine arranged in downstream fluid communication with an exhaust port to the combustion chamber and a compressor arranged in upstream fluid communication with an intake port to the combustion chamber.

4. The internal combustion engine arrangement of claim 3, wherein the turbo arrangement is an electrically controlled turbo arrangement.

5. The internal combustion engine arrangement of claim 4, wherein the electrically controlled turbo arrangement comprises an electric turbo motor between the turbine and the compressor.

6. The internal combustion engine arrangement of claim 5, wherein the electric turbo motor is operatively coupled to the processing circuit.

7. The internal combustion engine arrangement of claim 1, further comprising a supplementary motor connected to the crankshaft.

8. The internal combustion engine arrangement of claim 7, wherein the supplementary motor is an electric machine operatively coupled to the processing circuit.

9. The internal combustion engine arrangement of claim 8, wherein the electric machine is operable as an electric motor and as a generator.

10. The internal combustion engine arrangement of claim 8, wherein the electric machine is electrically connected to the combustion chamber pressure controller, the electric machine being configured to feed electric power to the combustion chamber pressure controller.

11. The internal combustion engine arrangement of claim 7, wherein the processing circuit is further configured to: determine a desired output torque on the crankshaft, and control the supplementary motor and the combustion chamber pressure controller contemporaneously in response to a difference between a current output torque and the desired output torque being above a predetermined torque threshold limit.

12. The internal combustion engine arrangement of claim 7, wherein the supplementary motor is directly attached to the crankshaft.

13. The internal combustion engine arrangement of claim 1, further comprising a first pressure sensor and a second pressure sensor.

14. The internal combustion engine arrangement of claim 13, wherein the first pressure sensor is configured to determine a first pressure value indicative of a pressure level in the combustion chamber.

15. The internal combustion engine arrangement of claim 13, wherein the second pressure sensor is configured to determine a second pressure value indicative of a pressure level in the crankcase.

16. The internal combustion engine arrangement of claim 13, wherein the first and second pressor sensors are operatively coupled to the processing circuit.

17. The internal combustion engine arrangement of claim 1, wherein the processing circuitry is configured to determine the pressure level in the combustion chamber from a memory comprising a plurality of stored pressure levels for a plurality of stored engine operating conditions.

18. The internal combustion engine arrangement of claim 17, wherein the processing circuitry is further configured to determine the pressure level in the crankcase from the memory, the memory further comprising a plurality of stored pressure levels in the crankcase for the plurality of stored engine operating conditions.

19. The internal combustion engine arrangement of claim 1, wherein the internal combustion engine is a hydrogen internal combustion engine.

20. A method of controlling an internal combustion engine arrangement, comprising an internal combustion engine, and a combustion chamber pressure controller arranged in fluid communication with a combustion chamber of the internal combustion engine, wherein the combustion chamber pressure controller is configured to control a pressure level in the combustion chamber, the method comprising: determining a pressure level in the combustion chamber of the internal combustion engine, determining a pressure level in a crankcase of the internal combustion engine, and controlling the combustion chamber pressure controller in response to a difference between the pressure level in the combustion chamber and the pressure level in the crankcase being below a predetermined threshold limit.
